(19) United States
(12) Patent Application Publication
(10) Pub. No.: US 2013/0146578 A1
(43) Pub. Date: Jun. 13, 2013

(54) HEATING DEVICE FOR HEATING ROLLERS IN LAMINATOR

(71) Applicants: Yen-Te Lee, Taipei (TW); Hui-Lan Tseng, Taipei (TW)

(72) Inventors: Yen-Te Lee, Taipei (TW); Hui-Lan Tseng, Taipei (TW)

(73) Assignee: PRIMAX ELECTRONICS LTD., Taipei (TW)

(21) Appl. No.: 13/425,150

(22) Filed: Mar. 20, 2012

(30) Foreign Application Priority Data
Dec. 12, 2011 (CN) 201110439715.3

(51) Int. Cl. H05B 3/02

(52) U.S. Cl. 219/244

(57) ABSTRACT

The present invention relates to a heating device for heating rollers in a laminator including a first insulating element, a heating element, a first electricity-conductive element and a first fixing element. The first electricity-conductive element includes a first connecting hole. The heating element winds around the first insulating element. In addition, a first end of the heating element hooks and thus connects with the first electricity-conductive element after passes through the first connecting hole. The first fixing element passes through the first connecting hole and the first insulating element, so as to fix the first electricity-conductive element and the first end of the heating element on the first insulating element.

### FIELD OF THE INVENTION

The present invention generally relates to a heating device, and more particularly to a heating device for heating rollers in a laminator.

### BACKGROUND OF THE INVENTION

A laminator is a kind of common office machines for laminating two films and an object, such as a photo or a business card, disposed between the two films. After the two films and the object disposed between the two films pass through a roller set inside the laminator, the object is sealed between the two films, so as to reduce the probability of the object being damaged and thus increase the storage life of the object. When a type of the films chosen to use by a user is non-adhesive, the two films need to be laminated together with a high temperature achieved by being transmitted through a roller set maintained at a specific laminating temperature.

As a result, such laminator is always equipped with a heating device disposed in the laminator for heating the roller set, while a commercially available device for heating the rollers in the laminator is practiced as illustrated in FIG. 1. FIG. 1 illustrates an explosion view of a conventional heating device for heating rollers in a laminator. Referring to FIG. 1, the heating device 1 for heating rollers in a laminator comprises a first insulating element 11, a heating element 12, two electricity-conductive elements 13 and two fixing elements 14. Herein, the first insulating element 11 comprises two fixing holes 11a located at two sides of the first insulating element 11, while the two electricity-conductive elements 13 respectively comprise a connecting hole 13a, and a size of each one of the connecting holes 13a is just capable of containing the corresponding one of the fixing elements 14.

Next, an assembling sequence of the conventional heating device for heating rollers in a laminator is illustrated herein after. The heating element 12 is winded around the first insulating element 11, and two ends 12a of the heating element 12 are respectively located adjacent to the two fixing holes 11a at the two sides of the first insulating element 11. The two electricity-conductive elements 13 respectively cover the two sides of the first insulating element 11 and respectively stack on and thus connect with the two ends 12a of the heating element 12. After that, the two fixing elements 14 respectively pass through the connecting holes 13a of the electricity-conductive elements 13 and the fixing holes 11a of the first insulating elements 11, so as to fix the two electricity-conductive elements 13 and the heating element 12 on the insulating element 11. In addition, the heating device 1 for heating rollers in a laminator further comprises a second insulating element 15 and a third insulating element 16 respectively covering and being fixed on two surfaces of the first insulating element 11 winded by the heating element 12.

After the heating device 1 for heating rollers in a laminator is electrified, the two electricity-conductive elements 13 transmit the electric power to the heating element 12, and thus the heating element 12 is heated, so as to heat the roller set of the laminator to a desired laminating temperature.

The main disadvantage of the foregoing heating device for heating rollers in a laminator is that the connection between the electricity-conductive element and the end of the heating element is formed by merely stacking them up and then clamping them together with the fixing elements, and thus the connection relationships between the electricity-conductive elements and the heating elements are weaker. As a result, in a long-term usage, a poor contact situation formed between the electricity-conductive elements and the ends of the heating element can be occurred once the fixing elements are slightly loose or an aging of the insulating element is occurred, and thus the failure probability of the device for heating rollers in a laminator is increased.

Accordingly, it is desired to provide an improved heating device for heating rollers in a laminator in order to overcoming the disadvantages of the conventional art.

### SUMMARY OF THE INVENTION

The present invention is directed to a heating device for heating rollers in a laminator, wherein a poor contact probability formed between the electricity-conductive element and the heating element is capable of being reduced.

The present invention is mainly directed to providing a heating device for heating rollers in a laminator comprising:
a first insulating element;
a heating element, winding around the first insulating element;
a first electricity-conductive element, comprising a first connecting hole,
wherein a first end of the heating element hooking and thus connecting with the first electricity-conductive element after passes through the first connecting hole of the first electricity-conductive element; and
a first fixing element, passing through the first connecting hole and the first insulating element, so as to fix the first end of the heating element and the first electricity-conductive element on the first insulating element.

In a preferred embodiment, the heating device for heating rollers in a laminator further comprises a second electricity-conductive element and a second fixing element, wherein the second electricity-conductive element comprises a second connecting hole. A second end of the heating element hooks and thus connects with the second electricity-conductive element after passes through the second connecting hole of the second electricity-conductive element. In addition, the second fixing element passes through the second connecting hole and the first insulating element, so as to fix the second end of the heating element and the second electricity-conductive element on the first insulating element.

In a preferred embodiment, the first electricity-conductive element and the second electricity-conductive element respectively connect with a first electric wire and a second electric wire, and the first electric wire and the second electric wire connect with the same power source.

In a preferred embodiment, both of the first fixing element and the second fixing element are rivets.

In a preferred embodiment, the heating device for heating rollers in a laminator further comprises a second insulating element and a third insulating element respectively disposed on an upper surface and a lower surface of the first insulating element winded by the heating element.

In a preferred embodiment, all of the first insulating element, the second insulating element and the third insulating element are mica sheets.

In a preferred embodiment, the heating element may be an iron-chromium wire or an aluminum-chromium wire.

The present invention is further directed to providing a heating device for heating rollers in a laminator comprising:
a first insulating element;
a first electricity-conductive element, comprising a first connecting hole;
a heating element, winding around the first insulating element, and a first end of the heating element connecting with the first electricity-conductive element; and
a first fixing element, passing through the first connecting hole and the first insulating element, so as to fix the first end of the heating element and the first electricity-conductive element on the first insulating element,
wherein the space of the first connecting hole of the first electricity-conductive element is capable of containing the first fixing element together with the first end of the heating element, so that the first end of the heating element hooks and thus connects with the first electricity-conductive element after passes through the first connecting hole.

In a preferred embodiment, the heating device for heating rollers in a laminator further comprises a second electricity-conductive element and a second fixing element, wherein the second electricity-conductive element comprises a second connecting hole. The second electricity-conductive element connects with a second end of the heating element, while the second fixing element passes through the second connecting hole and the first insulating element, so as to fix the second end of the heating element and the second electricity-conductive element on the first insulating element.

In a preferred embodiment, the space of the second connecting hole of the second electricity-conductive element is capable of containing the second fixing element together with the second end of the heating element, so that the second end of the heating element hooks and thus connects with the second electricity-conductive element after passes through the second connecting hole.

In a preferred embodiment, both of the first fixing element and the second fixing element are rivets.

In a preferred embodiment, the first electricity-conductive element and the second electricity-conductive element respectively connect with a first electric wire and a second electric wire, and the first electric wire and the second electric wire connect with the same power source.

In a preferred embodiment, the heating device for heating rollers in a laminator further comprises a second insulating element and a third insulating element respectively disposed on an upper surface and a lower surface of the first insulating element winded by the heating element.

In a preferred embodiment, all of the first insulating element, the second insulating element and the third insulating element are mica sheets.

In a preferred embodiment, the heating element may be an iron-chromium wire or an aluminum-chromium wire.

### BRIEF DESCRIPTION OF THE DRAWINGS

FIG. 1 illustrates an explosion view of a conventional heating device for heating rollers in a laminator.

FIG. 2 illustrates an explosion view of a heating device for heating rollers in a laminator according to a first embodiment of the present invention.

FIG. 3 illustrates a perspective view a first insulating element, a heating element, a first electricity-conductive element and a second electricity-conductive element of a heating device for heating rollers in a laminator according to a first embodiment of the present invention.

FIG. 4 illustrates a perspective view of a heating device for heating rollers in a laminator according to a first embodiment of the present invention.

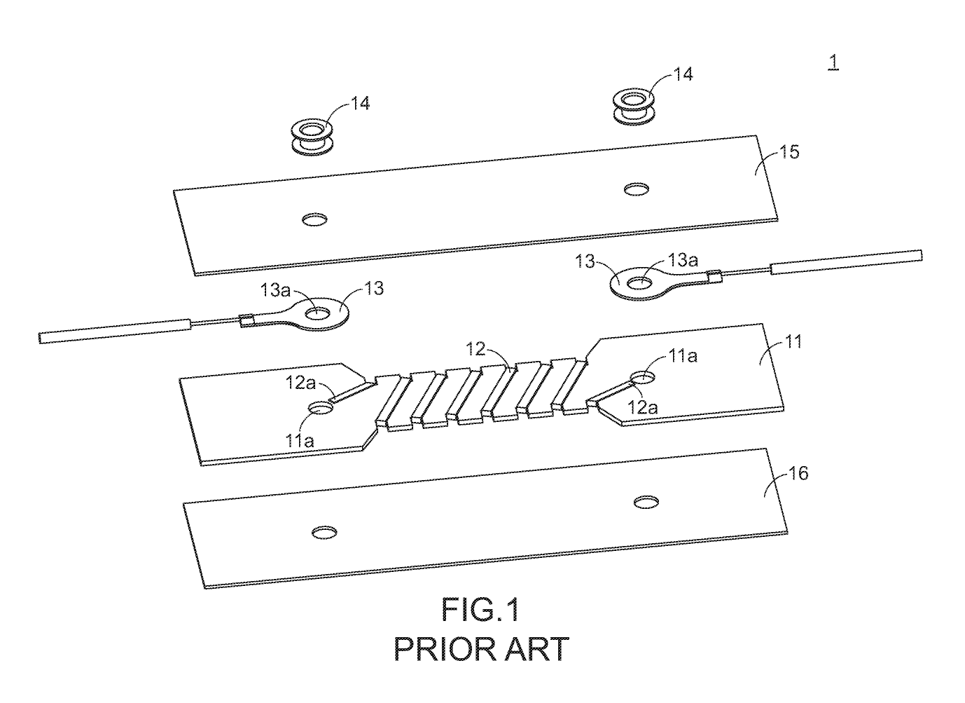

### DETAILED DESCRIPTION OF THE PREFERRED EMBODIMENT

A first specific embodiment according to the present invention provides a heating device for heating rollers in a laminator, which is capable of heating a roller set of a laminator.

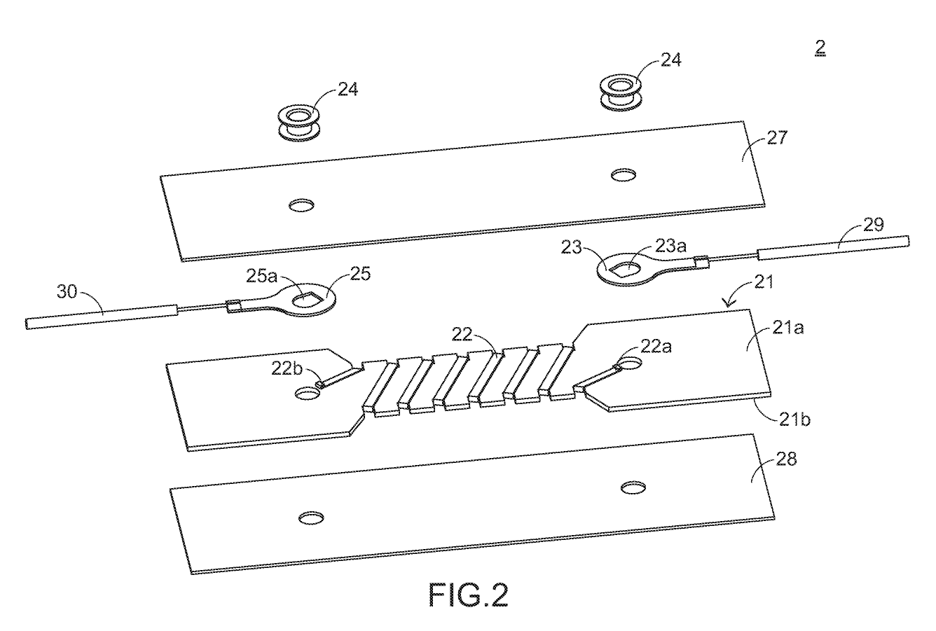

FIG. 2 illustrates an explosion view of a heating device for heating rollers in a laminator according to a first embodiment of the present invention. Referring to FIG. 2, the heating device 2 for heating rollers in a laminator comprises a first insulating element 21, a heating element 22, a first electricity-conductive element 23, a first fixing element 24, a second electricity-conductive element 25, a second fixing element 26, a second insulating element 27 and a third insulating element 28. Herein, the first electricity-conductive element 23 comprises a first connecting hole 23a, while the second electricity-conductive element 25 comprises a second connecting hole 25a. In the present embodiment, all of the first insulating element 21, the second insulating element 27 and the third insulating element 28 are mica sheets. In addition, the heating element 22 may be an iron-chromium wire or an aluminum-chromium wire. Besides, both of the first fixing element and the second fixing element are rivets.

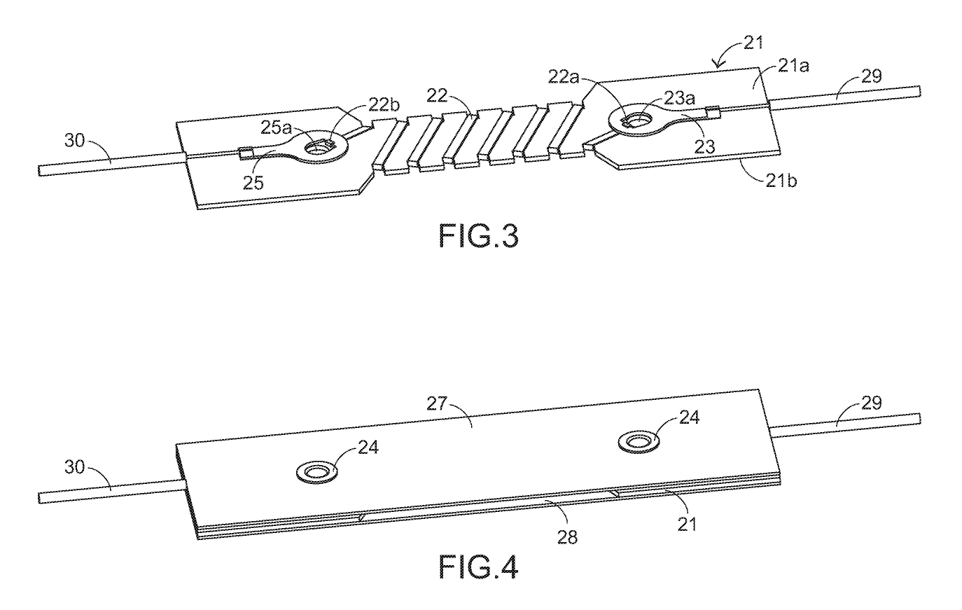

An assembly sequence of the heating device for heating rollers in a laminator according to the first embodiment of the present invention is illustrated herein after. Referring to FIG. 3 and FIG. 4 together, FIG. 3 illustrates a perspective view a first insulating element, a heating element, a first electricity-conductive element and a second electricity-conductive element of a heating device for heating rollers in a laminator according to a first embodiment of the present invention while FIG. 4 illustrates a perspective view of a heating device for heating rollers in a laminator according to a first embodiment of the present invention. As illustrated in FIG. 3, the heating element 22 winds around the first insulating element 21, wherein a first end 22a thereof is located at a side of the first insulating element 21, while a second end 22b thereof is located at another side of the first insulating element 21. The first electricity-conductive element 23 connects with the first electric wire 29, while the second electricity-conductive element 25 connects with the second electric wire 30, and the first electric wire 29 and the second electric wire 30 connect with the same power source (not shown).

The space of the first connecting hole 23a of the first electricity-conductive element 23 is capable of containing the first fixing element 24 together with the first end 22a of the heating element 22, so that the first end 22a of the heating element 22 hooks and thus connects with the first electricity-conductive element 23 after passes through the first connecting hole 23a of the first electricity-conductive element 23. In addition, the space of the second connecting hole 25a of the second electricity-conductive element 25 is capable of containing the second fixing element 26 together with the second end 22b of the heating element 22 as well, so that the second end 22b of the heating element 22 hooks and thus connects with the second electricity-conductive element 25 after passes through the second connecting hole of the second electricity-conductive element 25.

After that, the second insulating element 27 and the third insulating element 28 are respectively disposed on an upper surface 21a and a lower surface 21b of the first insulating element 21 winded by the heating element 22 as illustrated in FIG. 4. Next, the first fixing element 24 passes through a side of the second insulating element 27, the first connecting hole 23a of the first electricity-conductive element 23, a side of the first insulating element 21 and a side of the third insulating element 28, so as to laminate and fix the first end 22a of the heating element 22 and the first electricity-conductive element 23 at the side of the first insulating element 21.

Finally, the second fixing element 26 passes through another side of the second insulating element 27, the second connecting hole 25a of the second electricity-conductive element 25, another side of the first insulating element 21 and another side of the third insulating element 28, so as to laminate and fix the second end 22b of the heating element 22 at the other side of the first insulating element 21. Up to now, the heating device 2 for heating rollers in a laminator has been completely assembled.

It should be noted that although both of the first connecting hole 23a and the second connecting hole 25a are illustrated as D-shaped holes in the drawings of the present invention, neither the first connecting hole 23a nor the second connecting hole 25a of the present invention is intended to be limited as a D-shaped hole due to the drawings are only illustrated for exemplars.

After the power source is activated, the first electricity-conductive element 23 and the second electricity-conductive element 25 conduct an electric current toward the heating element 22. As a result, the heating element 22 is electrified and then heated, so as to heat the roller set of the laminator to a desired laminating temperature.

According to the above mentioned embodiments, it is understood that the end of the heating element of the heating device for heating rollers in a laminator of the present invention is capable of connecting with the electricity-conductive element after passing through and hooking the electricity-conductive element due to the electricity-conductive element has the connecting hole capable of containing the fixing element together with the end of the heating element.

As the above mentioned descriptions, a connection between the end of the heating element and the electricity-conductive element of the present invention is not formed by merely stacking up. However, it is formed by hooking and thus connecting the end of the heating element with the electricity-conductive element after passing the end of the heating element through the electricity-conductive element. As a result, a poor contact situation is not likely to occur between the end of the heating element and the electricity-conductive element even though an aging of the insulating element is occurred in a long-term usage. Accordingly, the failure probability of the heating device for heating rollers in a laminator can be reduced.

The above mentioned embodiments are merely illustrated for describing the ideas and the features of the present invention, which is directed to assisting the skilled in the art to understand and then practice the subject matter of the present invention. As a result, they do not intend to limit the scope of the claims of the present invention. In another word, all the variations and the modifications equivalent to the illustrating spirit according to the present invention should be included within the scope of the claims of the present invention.

What is claimed is:

1. A heating device for heating rollers in a laminator comprising:
a first insulating element;
a heating element, winding around the first insulating element;
a first electricity-conductive element, comprising a first connecting hole,
wherein a first end of the heating element hooking and thus connecting with the first electricity-conductive element after passes through the first connecting hole of the first electricity-conductive element; and
a first fixing element, passing through the first connecting hole and the first insulating element, so as to fix the first end of the heating element and the first electricity-conductive element on the first insulating element.

2. The heating device for heating rollers in a laminator as claimed in claim 1, further comprising a second electricity-conductive element and a second fixing element, wherein the second electricity-conductive element comprises a second connecting hole, a second end of the heating element hooks and thus connects with the second electricity-conductive element after passes through the second connecting hole of the second electricity-conductive element, while the second fixing element passes through the second connecting hole and the first insulating element, so as to fix the second end of the heating element and the second electricity-conductive element on the first insulating element.

3. The heating device for heating rollers in a laminator as claimed in claim 2, wherein the first electricity-conductive element and the second electricity-conductive element respectively connect with a first electric wire and a second electric wire, and the first electric wire and the second electric wire connect with the same power source.

4. The heating device for heating rollers in a laminator as claimed in claim 2, wherein both of the first fixing element and the second fixing element are rivets.

5. The heating device for heating rollers in a laminator as claimed in claim 1, further comprising a second insulating element and a third insulating element respectively disposed on an upper surface and a lower surface of the first insulating element winded by the heating element.

6. The heating device for heating rollers in a laminator as claimed in claim 5, wherein all of the first insulating element, the second insulating element and the third insulating element are mica sheets.

7. The heating device for heating rollers in a laminator as claimed in claim 1, wherein the heating element is an iron-chromium wire or an aluminum-chromium wire.

8. A heating device for heating rollers in a laminator comprising:
a first insulating element;
a first electricity-conductive element, comprising a first connecting hole;
a heating element, winding around the first insulating element, and a first end of the heating element connecting with the first electricity-conductive element; and
a first fixing element, passing through the first connecting hole and the first insulating element, so as to fix the first end of the heating element and the first electricity-conductive element on the first insulating element,
wherein the space of the first connecting hole of the first electricity-conductive element is capable of containing the first fixing element together with the first end of the heating element, so that the first end of the heating element hooks and thus connects with the first electricity-conductive element after passes through the first connecting hole.

9. The heating device for heating rollers in a laminator as claimed in claim 8, further comprising a second electricity-conductive element and a second fixing element, wherein the second electricity-conductive element comprises a second connecting hole, the second electricity-conductive element connects with a second end of the heating element, while the second fixing element passes through the second connecting hole and the first insulating element, so as to fix the second end of the heating element and the second electricity-conductive element on the first insulating element.

10. The heating device for heating rollers in a laminator as claimed in claim 9, wherein the space of the second connecting hole of the second electricity-conductive element is capable of containing the second fixing element together with the second end of the heating element, so that the second end of the heating element hooks and thus connects with the second electricity-conductive element after passes through the second connecting hole.

11. The heating device for heating rollers in a laminator as claimed in claim 9, wherein both of the first fixing element and the second fixing element are rivets.

12. The heating device for heating rollers in a laminator as claimed in claim 9, wherein the first electricity-conductive element and the second electricity-conductive element respectively connect with a first electric wire and a second electric wire, and the first electric wire and the second electric wire connect with the same power source.

13. The heating device for heating rollers in a laminator as claimed in claim 8, further comprising a second insulating element and a third insulating element respectively disposed on an upper surface and a lower surface of the first insulating element winded by the heating element.

14. The heating device for heating rollers in a laminator as claimed in claim 13, wherein all of the first insulating element, the second insulating element and the third insulating element are mica sheets.

15. The heating device for heating rollers in a laminator as claimed in claim 8, wherein the heating element is an iron-chromium wire or an aluminum-chromium wire.
